(19) United States
(12) Patent Application Publication
(10) Pub. No.: US 2013/0297468 A1
(43) Pub. Date: Nov. 7, 2013

(54) SYSTEMS AND METHODS FOR TRACKING TIME

(71) Applicant: CreativeWork Corporation, New York, NY (US)

(72) Inventors: Mark Hirsch, New York, NY (US); Mark Erickson, Palo Alto, CA (US); Melissa Phillips, Brooklyn, NJ (US)

(21) Appl. No.: 13/861,766

(22) Filed: Apr. 12, 2013

Related U.S. Application Data
(60) Provisional application No. 61/624,073, filed on Apr. 13, 2012.

(51) Int. Cl. G06Q 40/00

(52) U.S. Cl. CPC G06Q 40/105
USPC 705/32

(57) ABSTRACT

Systems and methods of the present disclosure facilitate tracking time. In some embodiments, the method obtains first time information. The first time information can be obtained via a timer embedded in an application executing on a first device. The method may associate the first time information with a first task identifier and generate a timesheet based on the associated first time information, which may include a unique indication of the first task identifier. The method may display the generated timesheet on a display of a mobile device. The method may modify the generated timesheet to include a second time information, which may correspond to a second task identifier. The timesheet can be modified via the mobile device touch interface. The method may display the modified timesheet with a unique indication of the second task identifier. The method may submit, via the mobile device, the timesheet to a time tracker server.

### CROSS-REFERENCES TO RELATED APPLICATIONS

This application claims priority to Provisional Application No. 61/624,073, titled “Systems and Methods For Tracking Time,” and filed on Apr. 13, 2012, the entirety of which is hereby incorporated by reference.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyright rights whatsoever.

### FIELD OF THE DISCLOSURE

This disclosure generally relates to systems and methods for tracking time. In particular, this disclosure relates to systems and methods for a time tracking platform that allows for embedded and automated time tracking, visual time management, and searching snapshots of documents based on tracked time.

### BACKGROUND OF THE DISCLOSURE

To accurately price, bill, and manage the performance of a task, companies or employees may need to accurately track the time spent on the task. In many work environments, the person performing the task (e.g., an employee, agent, contractor, consultant, service provider, third-party entity, or any other entity) may perform one or more tasks simultaneously or in quick succession, or even while they are traveling, e.g., on a portable computing device, smart phone, or a tablet computer. Often the multiple tasks are performed for multiple clients or are associated with multiple projects for a single client. In these and other scenarios, accurately and efficiently tracking the time spent working (or describing the work done) on a specific project for a specific client becomes consuming. The problem becomes even more time consuming and challenging when there are frequent diversions throughout the work day or when work is performed in a mobile environment.

### BRIEF SUMMARY OF THE DISCLOSURE

With the increased amount of work performed on computing devices and the resulting multitasking, it may be desirable to efficiently and accurately track the time spent on a task or project, as well as track the actual work performed. To address the challenges of tracking time spent and the work performed on a task, the present solution provides an embedded and automated time tracking system (“TTS”) that is based on the files with which a user of the computing device interacts. The TTS can integrate with various tools, such as creative tools, office tools, or email and file sharing programs to provide for automatic or manual updating of the user's time. The TTS can automatically update the user's time by tracking the files and projects user interacts with, as well as when, where, and for how long the users interacted with those files (and the type of activity or inactivity). For example, the TTS may embed or integrate a timer (or countdown timer) into a word processing document that automatically tracks the time being worked on the document and associates the time to a specific job identification number (“job ID”), client number, task number, or any other ID. The TTS may have one or more timers open at any given time, e.g., each word processing document may have its own open timer. The timer can be automatically or manually started/stopped or paused/resumed. For example, the user may simultaneously have a word document and an email program open on the computing device. The word document timer may only track time when the word document is the active window, and the email program timer may only track time when the email program is the active window. Thus, the TTS can facilitate accurate and efficient time tracking.

In some embodiments, the TTS may capture time data that can facilitate reporting time. Time data may include a plurality of information about a file and the user's interaction with the file, including, e.g., one or more saves, mouse actions, keystrokes, focus vs. not focus, changes in window attribute data (e.g., size, position, active, foreground, minimized, hidden). The TTS may apply one or more rules to the captured time data to determine when to track time, e.g., to determine when the user's interaction with the computing device is relevant or not relevant to a task or project. For example, the TTS may not update the time if a user simply opens a document and prints it without updating the document in any way. In some embodiments, the user can configure the time tracker to determine that a time entry is not relevant if the associated file was open for less than a certain amount of time. For example, if the file was open for under five minutes, the time tracker may deem the time entry to be not-relevant and thus not enter in the timesheet. In other embodiments, the time tracker may keep track of “not-relevant” time until it meets the threshold for relevancy. For example, the relevancy threshold of 10 minutes may be reached if the user opened the file four times for three minutes each time.

The TTS may generate and maintain a searchable history of the user's work by taking snapshots of files at predetermined time or progress increments. For example, for one or more open files, the TTS can grab a preview snapshot at a time interval. In some embodiments, the user may, via the TTS (or an external application or browser that accesses the data created by the TTS), visually search performed tasks stored by the TTS. For example, the TTS can provide an interface that allows the user to flip through thumbnails or snapshots of files corresponding to performed tasks. In some embodiments, the interface may include an interactive timeline. In some embodiments, the TTS may allow the user to search or filter files based on a plurality of search criteria, including, e.g., client number, task number, matter number, metadata associated with the file, contents of the file, user, date, time, last modified, last accessed, time spent, status, etc.

The TTS may visually automatically populate a timesheet with the tracked time. For example, the TTS may track time and capture associated data to determine that the user worked on a certain file between 10-11 AM and 1-3 PM. The TTS may provide the tracked data to user by populating a timesheet with the corresponding time and task numbers (the task number may be represented visually as a color). The TTS may provide this data to a user in a plurality of ways, including, e.g., by pushing the time data to a user's mobile computing device, smart phone, or tablet computer. The user, upon viewing the visual timesheet with the updated time, may modify the timesheet. For example, the TTS may not have tracked one or more tasks the user performed, such as tasks that were not performed on the computing device (e.g., teleconferences, office conferences, meetings, or reviewing physical documents). Upon viewing the visual representation of the tracked time, the user may determine that the TTS omitted time spent working on the task between 11 AM-12 PM and 3 PM-5 PM, and update the timesheet accordingly. The TTS may provide a plurality of user interfaces for viewing and modifying the tracked time and timesheet, including, e.g., touch gestures for a touch enabled computing device. Upon reviewing the time, the user may approve and submit the timesheet.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device;

FIGS. 1B and 1C are block diagrams depicting embodiments of computing devices useful in connection with the methods and systems described herein;

FIG. 2 is a block diagram of an embodiment comprising a time tracking system;

FIG. 3 is a flow diagram depicting an embodiment of a method of time tracking; and

FIGS. 4A-F are illustrations of embodiments of systems and methods of time tracking.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein; and
Section B describes embodiments of systems and methods for a time tracking system (“TTS”).

### A. Computing and Network Environment

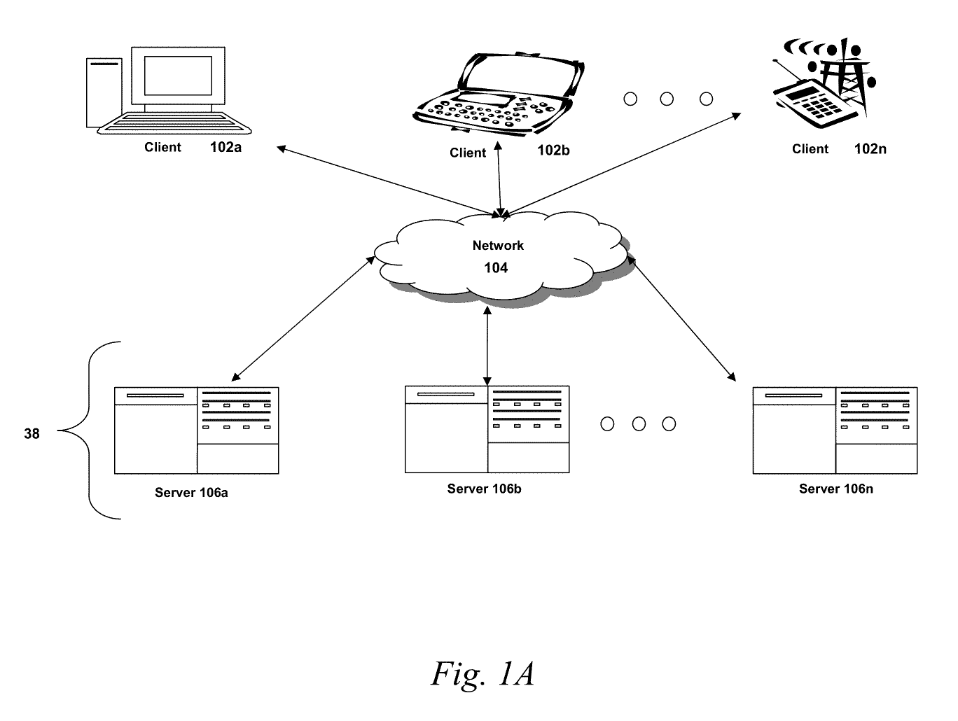

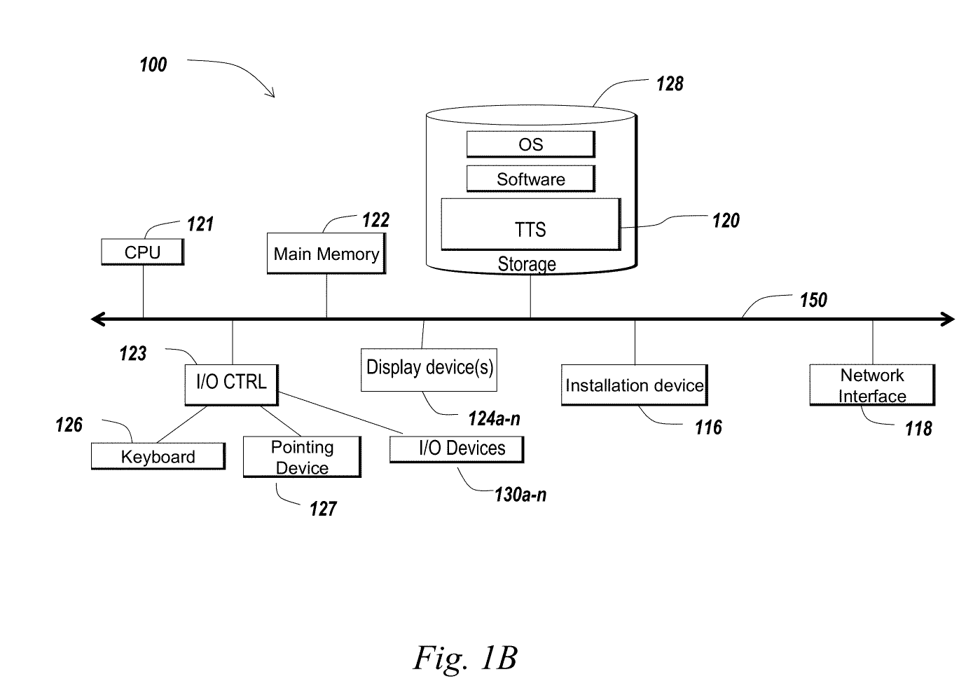

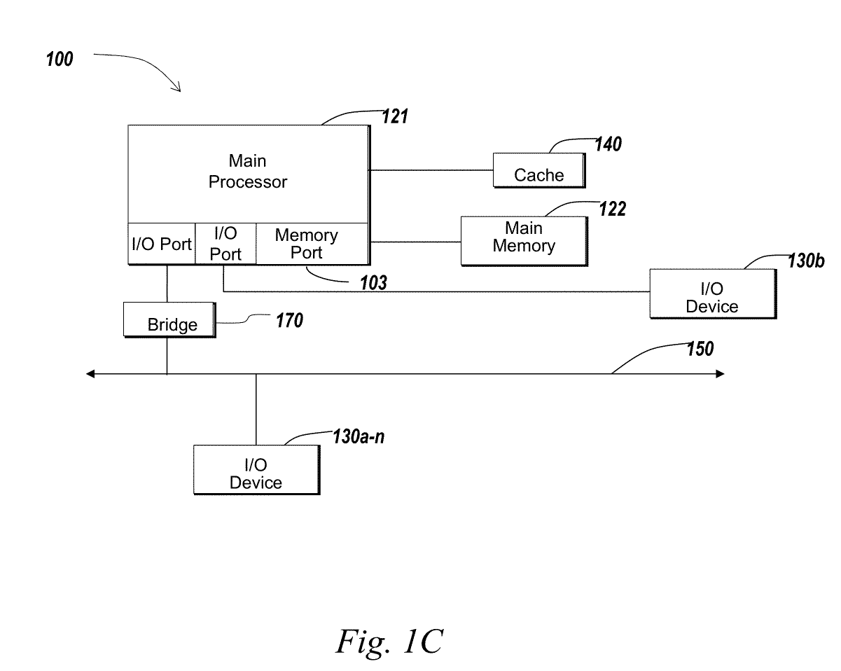

Prior to discussing specific embodiments of the present solution, it may be helpful to describe aspects of the operating environment as well as associated system components (e.g., hardware elements) in connection with the methods and systems described herein. Referring to FIG. 1A, an embodiment of a network environment is depicted. In brief overview, the network environment includes one or more clients 102a-102n (also generally referred to as local machine(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. The network 104 can be a local-area network (LAN), such as a company Intranet, a metropolitan area network (MAN), or a wide area network (WAN), such as the Internet or the World Wide Web. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ a public network. In still another of these embodiments, networks 104 and 104′ may both be private networks.

The network 104 may be any type and/or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In some embodiments, the system may include multiple, logically-grouped servers 106. In one of these embodiments, the logical group of servers may be referred to as a server farm 38 or a machine farm 38. In another of these embodiments, the servers 106 may be geographically dispersed. In other embodiments, a machine farm 38 may be administered as a single entity. In still other embodiments, the machine farm 38 includes a plurality of machine farms 38. The servers 106 within each machine farm 38 can be heterogeneous—one or more of the servers 106 or machines 106 can operate according to one type of operating system platform (e.g., WINDOWS NT, manufactured by Microsoft Corp. of Redmond, Wash.), while one or more of the other servers 106 can operate on according to another type of operating system platform (e.g., Unix or Linux).

In one embodiment, servers 106 in the machine farm 38 may be stored in high-density rack systems, along with associated storage systems, and located in an enterprise data center. In this embodiment, consolidating the servers 106 in this way may improve system manageability, data security, the physical security of the system, and system performance by locating servers 106 and high performance storage systems on localized high performance networks. Centralizing the servers 106 and storage systems and coupling them with advanced system management tools allows more efficient use of server resources.

The servers 106 of each machine farm 38 do not need to be physically proximate to another server 106 in the same machine farm 38. Thus, the group of servers 106 logically grouped as a machine farm 38 may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm 38 can be increased if the servers 106 are connected using a local-area network (LAN) connection or some form of direct connection. Additionally, a heterogeneous machine farm 38 may include one or more servers 106 operating according to a type of operating system, while one or more other servers 106 execute one or more types of hypervisors rather than operating systems. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the Xen hypervisor, an open source product whose development is overseen by Citrix Systems, Inc.; the VirtualServer or virtual PC hypervisors provided by Microsoft or others.

Management of the machine farm 38 may be de-centralized. For example, one or more servers 106 may comprise components, subsystems and modules to support one or more management services for the machine farm 38. In one of these embodiments, one or more servers 106 provide functionality for management of dynamic data, including techniques for handling failover, data replication, and increasing the robustness of the machine farm 38. Each server 106 may communicate with a persistent store and, in some embodiments, with a dynamic store.

Server 106 may be a file server, application server, web server, proxy server, appliance, network appliance, gateway, gateway, gateway server, virtualization server, deployment server, SSL VPN server, or firewall. In one embodiment, the server 106 may be referred to as a remote machine or a node. In another embodiment, a plurality of nodes 290 may be in the path between any two communicating servers.

The client 102 and server 106 may be deployed as and/or executed on any type and form of computing device, such as a computer, network device or appliance capable of communicating on any type and form of network and performing the operations described herein. FIGS. 1B and 1C depict block diagrams of a computing device 100 useful for practicing an embodiment of the client 102 or a server 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-102n, a keyboard 126 and a pointing device 127, such as a mouse. The storage device 128 may include, without limitation, an operating system, software, and the TTS 120. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 121, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC 100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 121 communicates with main memory 122 via a system bus 150 (described in more detail below). FIG. 1C depicts an embodiment of a computing device 100 in which the processor communicates directly with main memory 122 via a memory port 103. For example, in FIG. 1C the main memory 122 may be DRDRAM.

FIG. 1C depicts an embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1C, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 communicates directly with I/O device 130b via HYPERTRANSPORT, RAPIDIO, or INFINIBAND communications technology. FIG. 1C also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices include keyboards, mice, trackpads, trackballs, microphones, dials, drawing tablets, touch, finger gestures, body gestures. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices such as the USB Flash Drive line of devices manufactured by Twintech Industry, Inc. of Los Alamitos, Calif.

Referring again to FIG. 1B, the computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, Blu-ray DVD drive, a flash memory drive, tape drives of various formats, USB device, hard-drive or any other device suitable for installing software and programs. The computing device 100 may further comprise a storage device, such as one or more hard disk drives or redundant arrays of independent disks, for storing an operating system and other related software, and for storing application software programs such as any program related to the software 120 for the TTS. Optionally, any of the installation devices 116 could also be used as the storage device. Additionally, the operating system and the software can be run from a bootable medium, for example, a bootable CD, such as KNOPPIX, a bootable CD for GNU/Linux that is available as a GNU/Linux distribution from knoppix.net.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, CDMA, GSM, WiMax and direct asynchronous connections). In one embodiment, the computing device 100 communicates with other computing devices 100′ via any type and/or form of gateway or tunneling protocol such as Secure Socket Layer (SSL) or Transport Layer Security (TLS), or the Citrix Gateway Protocol manufactured by Citrix Systems, Inc. of Ft. Lauderdale, Fla. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Serial Attached small computer system interface bus, or a HDMI bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS VISTA, and WINDOWS 7, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

The computer system 100 can be any workstation, telephone, desktop computer, laptop or notebook computer, server, handheld computer, mobile telephone or other portable telecommunications device, media playing device, a gaming system, mobile computing device, or any other type and/or form of computing, telecommunications or media device that is capable of communication. The computer system 100 has sufficient processor power and memory capacity to perform the operations described herein. For example, the computer system 100 may comprise a device of the IPOD, IPHONE, IPAD, or APPLE TV family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or a NINTENDO WII device manufactured by Nintendo Co., Ltd., of Kyoto, Japan, an XBOX, XBOX 360, or XBOX KINECT device manufactured by the Microsoft Corporation of Redmond, Wash.

In some embodiments, the computing device 100 may have different processors, operating systems, and input devices consistent with the device. For example, in one embodiment, the computing device 100 is an IPHONE 1, 2, 3G, 3GS, 4, or 4S smart phone manufactures by Apple, Inc. In some of these embodiments, the IPHONE is operated under the control of the iOS operating system and includes systems and methods for touch input device. In other embodiments, the computing device may be a smart phone operated under the control of the GOOGLE ANDROID operating system.

In other embodiments the computing device 100 is a mobile device, such as a JAVA-enabled cellular telephone or personal digital assistant (PDA), such as the i55sr, i58sr, i85s, i88s, i90c, i95c1, or the im1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea. In some embodiments, the computing device 100 is a mobile device manufactured by Nokia of Finland, or by Sony Ericsson Mobile Communications AB of Lund, Sweden.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry Pearl 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 is a digital audio player. In one of these embodiments, the computing device 100 is a digital audio player such as the Apple IPOD, IPOD Touch, and IPOD NANO lines of devices, manufactured by Apple Computer of Cupertino, Calif. In another of these embodiments, the digital audio player may function as both a portable media player and as a mass storage device. In other embodiments, the computing device 100 is a digital audio player such as the DigitalAudimpression opportunity layer Select MP3 players, manufactured by Samsung Electronics America, of Ridgefield Park, N.J., or the Motorola m500 or m25 Digital Audio Players, manufactured by Motorola Inc. of Schaumburg, Ill. In still other embodiments, the computing device 100 is a portable media player, such as the Zen Vision W, the Zen Vision series, the Zen Portable Media Center devices, or the Digital MP3 line of MP3 players, manufactured by Creative Technologies Ltd. In yet other embodiments, the computing device 100 is a portable media player or digital audio player supporting file formats including, but not limited to, MP3, WAV, M4A/AAC, WMA Protected AAC, RIFF, Audible audiobook, Apple Lossless audio file formats and .mov, .m4v, and .mp4MPEG-4 (H.264/MPEG-4 AVC) video file formats.

In some embodiments, the communications device 102 includes a combination of devices, such as a mobile phone combined with a digital audio player or portable media player. In one of these embodiments, the communications device 102 is a smartphone, for example, an iPhone manufactured by Apple Computer, or a Blackberry device, manufactured by Research In Motion Limited. In yet another embodiment, the communications device 102 is a laptop or desktop computer equipped with a web browser and a microphone and speaker system, such as a telephony headset. In these embodiments, the communications devices 102 are web-enabled and can receive and initiate phone calls. In other embodiments, the communications device 102 is a Motorola RAZR or Motorola ROKR line of combination digital audio players and mobile phones.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Time Tracking System (TTS)

To address the challenges of accurately and efficiently tracking time spent working on a project, the present solution provides an embedded, integrated, visual and searchable time tracking system (“TTS”). The TTS can integrate or be embedded with any software application, including, e.g., creative tools, graphics editing programs, word processing programs, presentation programs, spreadsheet programs, video editing programs, email programs, web browsers, video/teleconferencing programs, calendars, computer games, etc.

The TTS can include a plurality of timers and counters that perform various functions. The timers can be open for one or more files, paused/resumed at any time, adjusted for a certain time, be associated with a project ID (which may be retrieved from a lookup table), or set to countdown from a specified time for a specified project. The TTS may include alarms/reminders that can be set based on timers or counters. For example, a user may want to be notified upon completing 50% of a project, or after 4 hours of working on a specific project in order to move on to the next project. The TTS can also publish timers or counters for other users of the TTS to subscribe to and/or monitor. For example, a manager of a certain project may subscribe to an employee's timer in order to monitor the employee's status. For example, a manager (or executive, supervisor, project manager, etc.) can view a dashboard that includes a composite of the data being collected in real-time. In some embodiments, billings can be estimated based on prior experience of each individual, e.g., based on the amount of work done by the individual during a certain time period, the quality of work, the level of the work, the amount billed for the work and the amount received for that work, etc.

The TTS can classify tracked time as relevant (for time tracking) or not-relevant (for time tracking). Relevancy can be set by the TTS or user of the TTS and may further be configurable based on rules. For example, if a file is opened and closed without saving, the TTS may infer that the user did not do any work and deem the tracked time to be not-relevant for billing purposes. Upon shutting down a program, the TTS may prompt a user to clean up the data collected during the recent session. The data may include captured time data, snapshot data, or one or more timers/counters associated with the project. In some embodiments, cleaning up data may include populating a timesheet with the tracked data. In some embodiments, cleaning up data may include analyzing the tracked data to determine if it is accurate, deleting non-relevant data, or otherwise modifying the tracked data in order accurately report time.

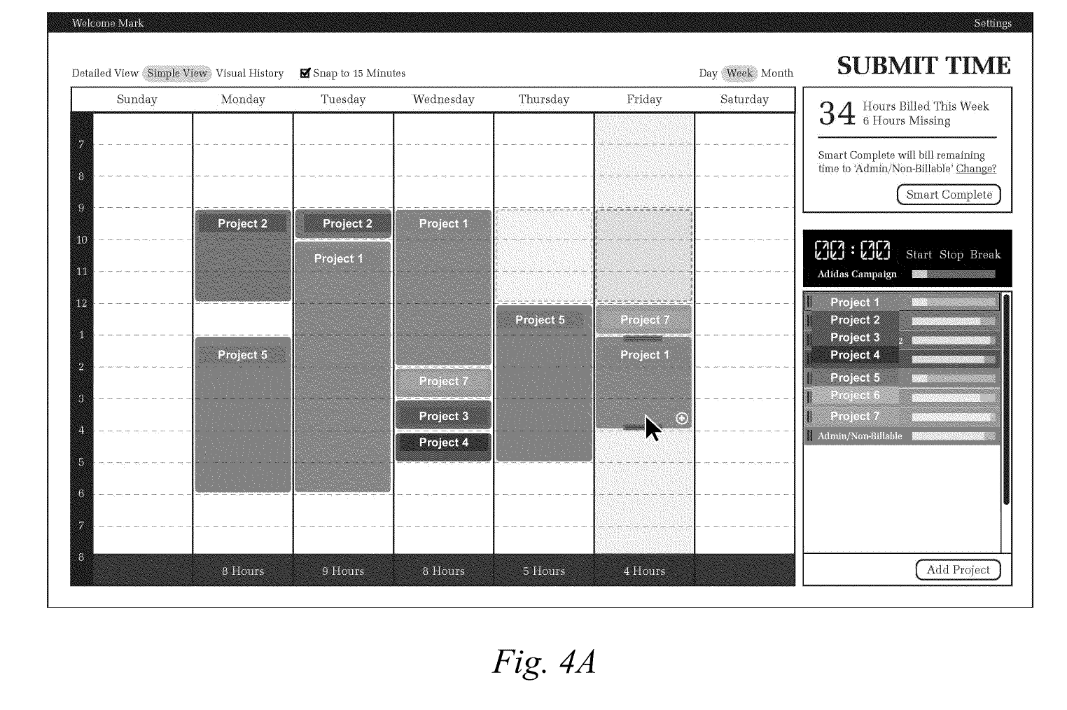

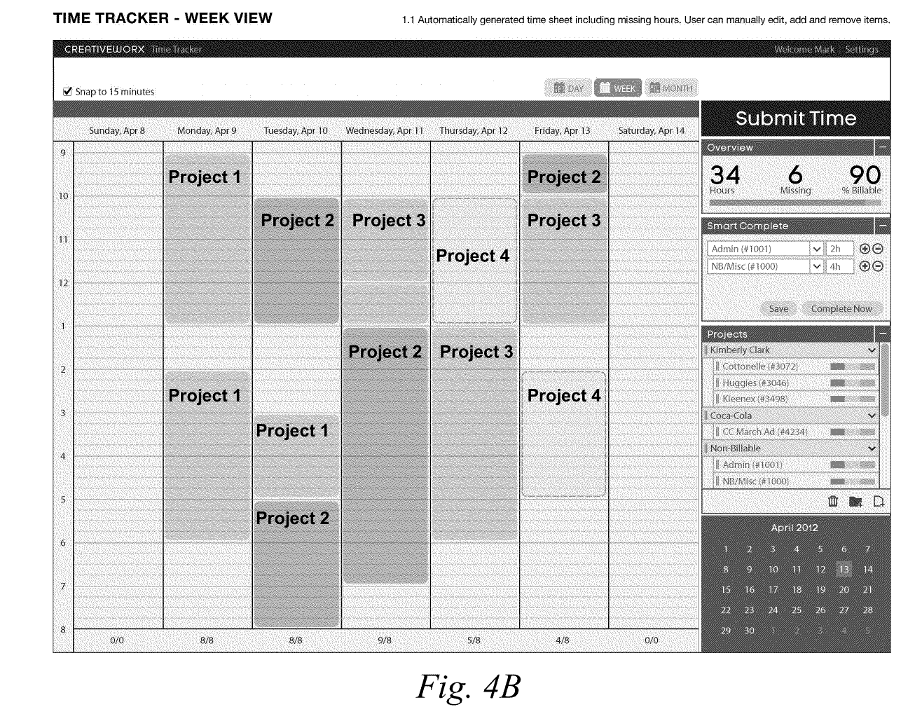

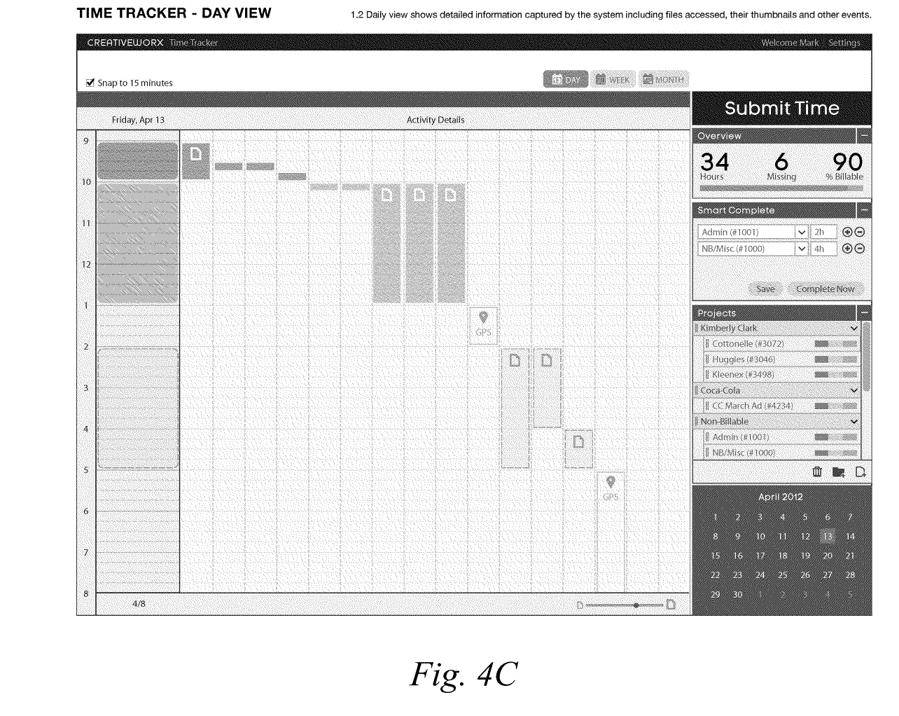

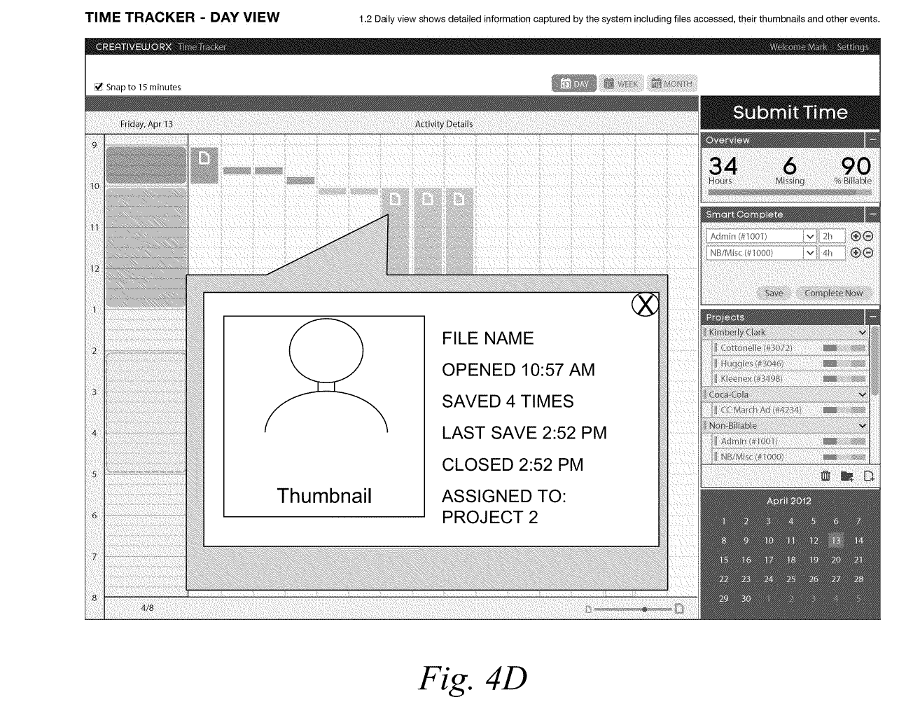

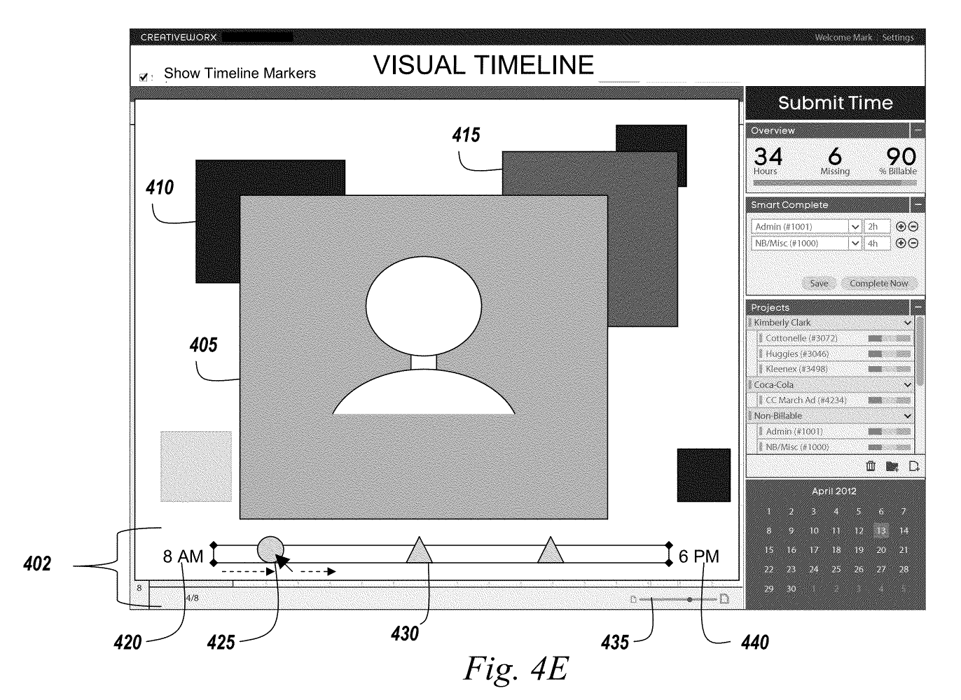

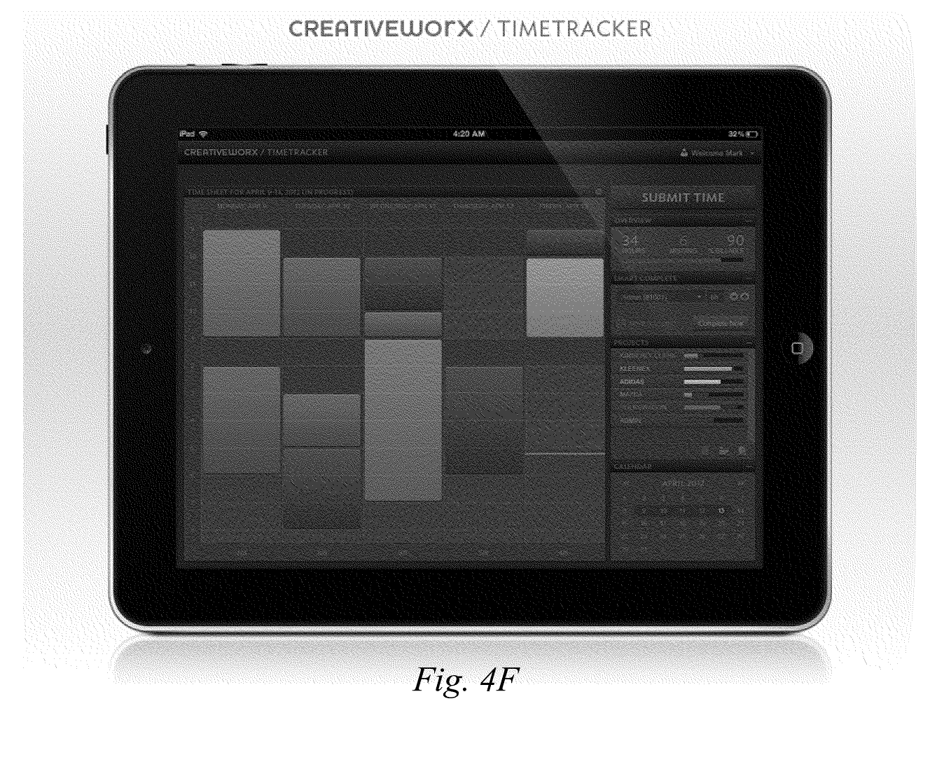

Briefly, an illustrative visualization of a timesheet provided by the TTS is shown in FIG. 4A. The TTS may include a plurality of interactive visual timesheets. In some embodiments, the visual timesheets may represent a calendar view that displays captured data, with previews corresponding to actual times. A user may mouse over an actual time to reveal additional project/time data. The calendar view may include hidden areas that contain the not-relevant time data, which can be easily revealed upon user selection, thus allowing the user to review, edit and change relevancy for such data. The GUI including the calendar view may also include a project list next to the calendar that contains a list of project that are associated with the user during a given time interval. Each project may have a color swatch that is visually unique in order to easily and visually distinguish one project from another. Additionally, the user may be able to add or create new projects to the project list for association with user time data. Tapping (via finger gestures if touch enabled computing device, otherwise via mouse clicks) a project in the project list and then touching a block of time (either to update pre-existing data or to add new data for the identified project). When adding a new project, the TTS may, by default, assign a unique color or prompt the user to assign a unique color. The project color may be standardized for all users of the TTS associated with the project. In some embodiments, the TTS can automatically complete (“smart complete”) one or more entry or perform one or more task related to time tracking. In some embodiments, the TTS may automatically parse information about the project to assign a project color. For example, the TTS can automatically assign a color to various projects based on a plurality of factors, including, e.g., the colors already assigned to other projects, the colors assigned to other or the same project for other users, the importance or priority of the project, the client the project is for, the type of project or tasks related to the project, etc.

In some embodiments, the TTS may visualize aspects of time tracking by presenting a user with a thumbnail that includes tracked and/or captured data. For example, the thumbnail may include one or more a snapshots of one or more files worked on by the user. The user may review a block of time, e.g., cycle through time entries or preview snapshots. In some embodiments, a user (e.g., manager of a project) can subscribe to multiple projects that are shared or published by others in order to review or monitor the time data. In some embodiments, the user may review these projects in real-time or periodically receive time data summaries that include current preview, last preview, timer, counter, information about other users recording time towards the same project, etc.

In some embodiments, the TTS may prompt a user with a reminder to submit a timesheet in advance of the timesheet submission deadline. The TTS may provide the user with a reminder in a plurality of ways, including, e.g., via SMS, email, pop-up with a software application program, or upon launch of a software application. In some embodiments, the TTS may analyze historical data for a user or project or task type to predict timesheet submissions based on currently logged data. For example, if the user has not timely submitted a timesheet, the TTS may project, based on the user's historical timesheet data, what the current timesheet may look like. In some embodiments, the TTS may employ one or more predictive analysis techniques to predict timesheet submissions, estimate current or future timesheets, or automatically complete timesheets. Predict analysis techniques may include statistical techniques from modeling, machine learning, data mining, and game theory that analyze current and historical facts to make predictions about future events.

The TTS may transmit a user's time data, including snapshot previews, to a user's smart phone or tablet computing device. The TTS may push the data in real-time as updated data becomes available, even in advance of the user accessing the device. In some embodiments, the user may clean up time entry data via their smart phone or tablet computer when the TTS pushes time data to the user's mobile computing device. For example, the user may work for eight hours in the office and the TTS may automatically track the time. The user may shut down the office computer without submitting a timesheet for the day. Upon shut down, the TTS may push the user's time data to the user's mobile device so the user can review the automatically tracked time data, review snapshots, project IDs, activity details, modify one or more time entry, or add comments, and proceed to approving and/or submitting the timesheet. In some embodiments, the TTS may include an offline mode (i.e., no network connection) that can allow the user to review or modify the data, add comments, approve the timesheet, and/or make an indication to submit the timesheet. For example, upon taking one or more of these actions, the user device may store information about one or more of these actions in a local database on the computing device. The user device may automatically or manually sync the data with the TTS once the user device's network access has been restored. In some embodiments, the user can authorize other uses to access and clean up the user's time data. Thus, the TTS may facilitate mobile timesheet review and submissions, i.e., the ability to review and submit time data from any computing device that can access the TTS.

In some embodiments, the TTS may track time by gathering user interactions and events within creative suite applications, such as graphics editing programs, video editing programs, image editing programs, or any other software application. User interaction data may include determining what document is frontmost, activation/deactivation, menu commands, typing, mouse movements, and/or other application specific actions. The TTS may capture a plurality of data associated with tracking time. Data capture may be performed on the operating system level, e.g., tracking what files are open, applications that are started/terminated, computer shut down, startup, and user interactions with the mouse and keyboard or touch screen. Data capture may include email client data capture, such as email timeline activity, files included in an email, associations and relationship to people. Data capture may include file service data capture, such as information about what files are saved, and/or with whom the files are shared via an online file sharing service. Data capture may include information about projects, metadata about what files are saved and with whom. Data capture may include geolocation data capture, e.g., from a mobile device, smartphone, notebook, desktop, that facilitate recording or tracking time for a task. Data capture may include information from calendar applications and services, such as Microsoft Outlook and Google Calendar.

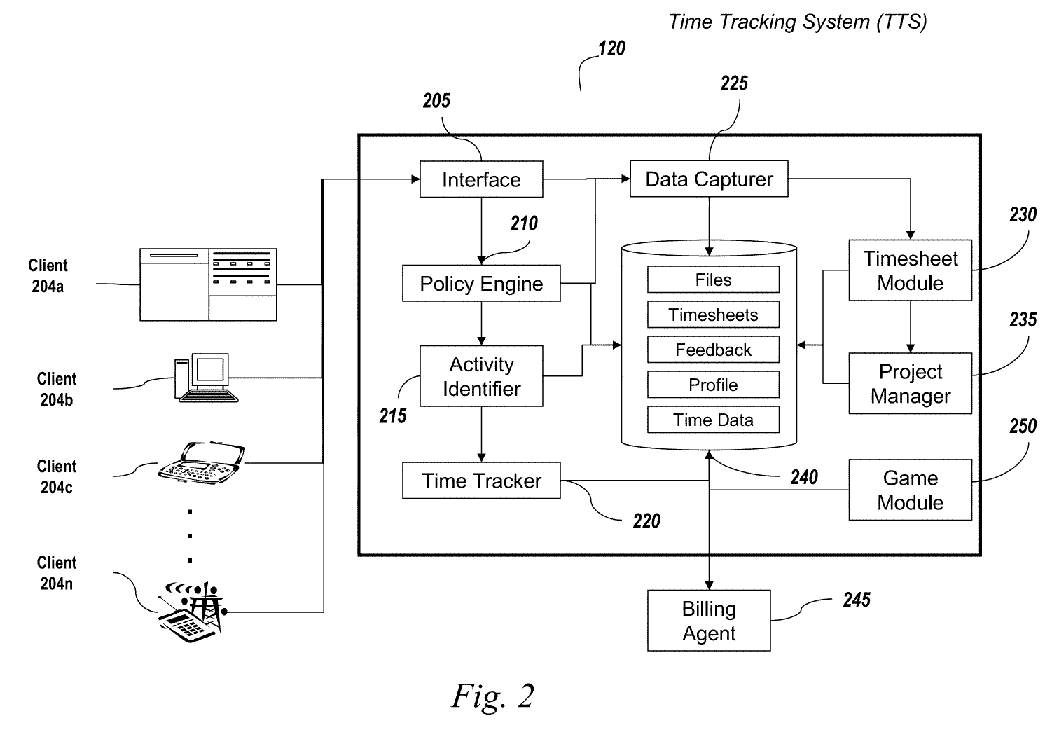

Referring to FIG. 2, embodiments of a system for time tracking is depicted. In brief overview, the TTS 120 can include one or more user clients 204a-n that allow users to perform a plurality of functions and interact with the TTS to, e.g., track time, populate timesheets, analyze timesheets, modify timesheets, search time history, search work history, manage projects, or collaboratively manage project with other users. The TTS can include an interface 205 that is used by the user clients to communicate and interact with the TTS. The TTS can include a policy engine 210 that provides, e.g., authentication and authorization. The TTS may include an activity identifier 215 that determines a project identification number (“project ID”), job ID, client ID, task ID, or any other ID with which tracked time can be associated. The TTS may include a time tracker 220 that can track time, start/stop time, pause/resume time, or countdown time spent on a task associated with an ID. The TTS may include a data capturer 225 that can capture time data, including, e.g., user interactions such as mouse and keyboard input. The data capturer 225 may further capture snapshots of documents or files that are being tracked. The TTS may include a timesheet module 230 that can populate, manage, visualize a timesheet. The TTS may include a project manager 235 that maintains deadlines, alarms, monitors project status, and provides notifications to users, project managers, and clients. The TTS may include a database 240 that can contain data received, used, and generated by components and modules 205, 210, 215, 220, 225, 230, and 235. The data can be about file snapshots, timesheets, project data, user profiles, or captured time data.

In further detail, the TTS 120 includes a plurality of user clients 204a-n designed and constructed to allow users to perform a plurality of functions and interact with the TTS or other users. The user clients may be one or more clients 102 described above, and comprise, e.g., a computing device containing one or more processors, memory, a display, and input/output devices. In various embodiments, the user clients are desktop computers, laptop computers, netbooks, tablet computers, smart phones, mobile phones, PDAs, touch screen enabled devices, etc. The user clients may comprise an application, program, library, script, service, process, task or any type and form of executable instructions executing on a device, such as a client or a server. In one embodiment, the TTS application may be a stand alone application on a user client. In another embodiment, the TTS application may be integrated into a program being used by a user on a computing device.

In one embodiment, the TTS application may be an add-in or add-on application. The TTS may add-in to any application or program that can be accessed by via a computing device. An add-in may be any software program that extends the capabilities of larger programs. For example, there are many add-ins for Microsoft Word that are designed to add the basic functionality offered by the word processing program. In one embodiment, an add-in may employ object linking and embedding (“OLE”), which is a compound document standard developed by Microsoft. Via OLE, objects may be created with one application and then linked or embedded to a second application. Embedded objects may retain their original format and links to the application that created them. The TTS application may employ any other system or method to add-in to another program, including, e.g., the OpenDoc format developed jointly by IBM and Apple Computer.

In another embodiment, the TTS application may be a stand-alone application executing on a client. The TTS may, e.g., interface with one or more larger programs to send/receive necessary data. In another example, the TTS application may be a stand-alone application that does not interface with any other programs on the client. In this example, the user may still be able to interact with all TTS functions that do not require an interface, and the TTS may further be able to track time and any other information associated with time tracking (e.g., file snapshots and time data capture). For example, a user may be able to view or interact with a timer, enter a project ID, populate/modify a timesheet, track time/file history, etc.

In some embodiments, the TTS application may comprise software as a service (“SaaS”). In these embodiments, the TTS application and its associated data may be hosted centrally, e.g., on a server, in the Internet, in the cloud, and accessed by users using a thin client, e.g., a web browser over the Internet. In one embodiment, a user can alter the set of configuration options that affect its functionality and look-and-feel. Each user may have their own settings for the configuration options.

In some embodiments, the user may launch and use the TTS application without it being linked, integrated, or embedded with the program for which time/user interaction is being tracked. The user may still perform some or all functions related to the TTS, and the TTS may still track time and other information associated with the program and user interaction. For example, the user may launch the standalone TTS application and then select, via the TTS user interface, the program (e.g., word processor) for which the TTS may track time and time information. Thereafter, the TTS can automatically launch each time the word processing program is launched and further embed or integrate into the user interface of the word processing program or otherwise link to the word processing program. For example, the TTS may always be running in the background and periodically scan running programs to determine what programs are running. Based on the running programs, the TTS can automatically determine whether to track time or other time information.

The user client 204 comprises a user interface that may be any type or form of interface, such as a graphical user interface (GUI) and/or a command line interface. The interface may be a web interface. The interface may be an application interface. The interface may be a text interface via texting, instant messaging, chatting and the like. The interface may be an application executing on a mobile device. For example, a companion application may run on a tablet or smart phone (or any other mobile device or any other computing device) while the corresponding primary TTS application may run on another computing device, e.g., on a laptop or desktop computer. The companion application running on the tablet or smart phone can allow a user to identify a project while working in their software application of choice. For example, the primary TTS application may determine that the user launched a word processing program on a desktop computer. The TTS may then prompt the user, via the user interface of the companion application running on the smart phone, to enter a project ID or other time tracking data. Further to this example, the user may input data responsive to the prompt from the TTS via the companion application and/or the primary application. In some embodiments, the companion application may display a timer and provide any other TTS functionality. In some embodiments, the companion application may provide the sole TTS user interface, while primary TTS application runs in the background of a laptop or desktop computer and is at least partially hidden from the user. Portions of the interface and interface content may be provided by a locally-executing application (e.g., software program) on a user client 204a-n and/or client machine 102. Portions of the interface and interface content may be remotely transmitted from a server 106 to a client machine 102 for presentation (e.g., on a browser executing on the client machine 102).

The user interface may present and provide access to the functionality, operations and services of the TTS via network 104. To implement the functionality of the TTS, the interface may include any number of user interface components generally referred to as widgets. A widget may comprise any one or more elements of a user interface which may be actionable or changeable by the user and/or which may convey information or content. Interface widgets may comprise any type and form of executable instructions that may be executable in one or more environments. Each widget may be designed and constructed to execute or operate in association with an application and/or within a web-page displayed by a browser. One or more widgets may operate together to form any element of the interface, such as a dashboard. The user interface may include any embodiments of the user interfaces described in FIGS. 4A-4E or any portions thereof or functionality provided such user interfaces.

The user client 204 can be configured for a user to perform a plurality of functions related to the time tracking system. A user may be a person or an entity that is performing a task, responsible for preparing a work product, an agent of a company or otherwise associated with an entity that is interested in tracking the user's time and time information. In one embodiment, the user may be a third party that is responsible for performing a task for an entity. A task may be any function associated with an entity for which the user is getting compensated for. A task may also include administrative functions that one or more entities may not directly compensate for, e.g., overhead functions, timekeeping functions, professional development, business development, etc. In some embodiments, the task may be performed on a computing device and may reside in memory. In other embodiments, performing the task may involve interacting or working with a physical product, e.g., a painting, drawing, sculpture, etc., or interacting with other people in meetings. In some embodiments, snapshots of physical work products may be submitted to the TTS by taking a photograph or video of the work product, converting it to a computer readable format, and electronically transmitting it to the TTS. For example, a user may periodically take a digital photograph of a painting and upload the digital photograph to the TTS and associate the digital photograph with an ID.

The user can, via user client 204a-n, submit time information to the TTS. In one embodiment, the user may submit/modify time information via the user interface using an input device, including, e.g., a keyboard, mouse, stylus, touch screen, etc. In another embodiment, the user may instruct the TTS to automatically track time and other information. In one embodiment, the user interface of the TTS may integrate with a software application. In another embodiment, the TTS user interface may run as an add-on to the software application. The TTS user interface may launch concurrently with the launch of a software application, or the TTS user interface may be launched from within the software application via a button, drop down menu, or other input command via a user interface. In another embodiment, the user client component of the TTS may be a stand-alone application running on a computing device.

Via the user client, the user may begin, modify, perform, monitor, and/or terminate any function related to the TTS, including, e.g., functions related to the policy engine 210, activity identifier 215, time tracker 220, data capturer 225, timesheet module 230, project manager 235, database 240 or billing agent 245. These functions will be discussed further in relation to modules, engines, and graphical user interfaces.

The TTS 120 can comprise an interface 205 designed and constructed to interface to any type and form of user client, or any other data source, client, or server. The interface module can be configured to interface with any other module, component, engine, or database. The interface may comprise an application, program, library, script, service, process, task or any type and form of executable instructions executing on a device. In some embodiments, the interface 205 is designed and constructed to receive and submit any data, including, e.g., time data, text, phrases, task descriptions, snapshots, audio, video, notifications, instructions, feedback, etc.

The TTS 120 can comprise a policy engine 210 designed and constructed to receive data from clients and/or servers via the interface and make a decision. The policy engine may comprise an application, program, library, script, service, process, task or any type and form of executable instructions executing on a device, such as a client or a server. The policy engine can be configured to interact with any other module or engine.

In one embodiment, the policy engine authenticates user clients and/or program managers. Authentication may refer to the process where the identity of an entity is authenticated by, e.g., providing evidence that the entity holds a specific digital identity such as an identifier and the corresponding credentials. For example, credentials may be passwords, one-time tokens, digital certificates, phone numbers, etc. The policy engine may allow an entity that passes the authentication process to perform a plurality of functions related to the TTS.

In another embodiment, the policy engine 210 authorizes a plurality of clients and/or servers to perform a plurality of activities or functions. Authorization may be determined based on a range of criteria or restrictions. In one embodiment, a user may authorize all or a subset of users to perform all or a subset of functions. TTS functions may be time tracking, data capture, file snapshot capture, timesheet modification, timesheet submissions, invoice generations, etc. In some embodiments, only certain users may be authorized to generate and/or submit invoices. In some embodiments, only certain users may be authorized to access timesheet data of one or more users associated with a project or client. For example, the policy engine may only authorize the project manager to access or modify timesheet data of all users associated with the project. In one embodiment, the policy engine may use data in the database 240 to make an authorization determination.

The TTS 120 can comprise an activity identifier 215 designed and constructed to identify an activity for which time data is to be tracked. The activity identifier may comprise an application, program, library, script, service, process, task or any type and form of executable instructions executing on a device, such as a client or a server. The activity identifier can be configured to interface with any other module or engine, including, e.g., an interface, policy engine, time tracker, data capturer, timesheet module, project manager, database, and billing agent to perform a plurality functions.

In some embodiments, the activity identifier 215 determines a project ID, task ID, client ID, matter ID, administrative function ID, or any other ID for which time is to be tracked. In some embodiments, the activity identifier may, via the interface, provide the user with a prompt, pop-up window, dropdown list, input text box, buttons, or any other user interface for receiving an identifier from a user. For example, the activity identifier may provide the user with a lookup table that includes a plurality of identifier with which time data or file data can be associated. An identifier may be any combination of characters, letters, numbers, symbols, etc.

For example, the TTS may launch concurrently with the launch of a blank word processing document. The activity identifier may prompt the user to enter a client name or project name and then automatically determine the associated identifier. For example, the user may enter enter Client_Blue and Task_One. The activity identifier may then correlate this information with information in the database 240 to determine that Client_Blue and Task_One corresponds to the identifier CB-001.

In another example, the activity identifier may generate a new identification number based on the received input. For example, the user may be working on a new task for Client_Blue that does not already have an identifier stored in the database. Instead of waiting for another entity to generate an identifier, the activity identifier may automatically generate an identifier for the task in order to track time information.

In some embodiments, the activity identifier may automatically determine an ID based on the software application being used by the user and/or the content of the software application. For example, the activity identifier may parse text or metadata of a word document to automatically determine the client and task number. For example, the document may contain, in the title, header, or footer, identification information that corresponds to a project ID or task ID.

The TTS 120 can comprise a time tracker 220 designed and constructed to track time spent performing a task. The time tracker may comprise an application, program, library, script, service, process, task or any type and form of executable instructions executing on a device, such as a client or a server. The time tracker can be configured to interface with any other module or engine, including, e.g., an interface, policy engine, activity identifier, data capturer, timesheet module, project manager, database, and billing agent to perform a plurality functions.

The time tracker may track time at any time interval, including, e.g., seconds, minutes, tenth of an hour, quarter hours, etc. The time tracker can round up or down to the nearest time interval. For example, if the time tracker is set to track time at quarter hour intervals, the time tracker may round up twenty-five minutes to half-an-hour.

In some embodiments, the time tracker may include a timer interface. The timer interface may be integrated or embedded in a software application. In other embodiments, the timer interface may be a stand-alone application. In yet other embodiments, the timer may be a stand-alone device or apparatus running a timer application that is linked to the TTS. For example, the time tracker interface may run on a mobile or tablet operating system that is running on a mobile device or tablet. The user may interface with the time tracker via the mobile device or tablet computer using touch gestures, a mouse, or a keyboard.

In some embodiments, the TTS may launch a plurality of time trackers for a user. For example, the user may have one or more word processing documents, power point presentations, graphics editing programs, and Internet browsers open on a computing device. In some embodiments, the TTS may launch a time tracker that can run in the background of a mobile operating system running on a smart phone. For example, the activity identifier may automatically detect when the user of a smart phone accesses an email related to an identifier stored in the database. The activity identifier may then direct the TTS to launch a time tracker, or start tracking the time the user spent interacting with the email on the smart phone. In another example, the TTS may automatically detect when the user of a smart phone is on a voice call associated with an identifier stored in the database. For example, the activity identifier may automatically determine that a certain contact is a client for which the user performs one or more tasks. Upon receiving or making a call to this client, the activity identifier may automatically direct the TTS to track the duration of the telephone conversation. In some embodiments, the TTS may then prompt the user for additional input regarding the telephone conversation, including, e.g., whether it should be accounted, a confirmation of the task ID, a description of what was discussed, etc. The system can also notice computer inactivity, prompting the user at some later point in time to identify the activity that occurred during the inactive time period. In some embodiments, the TTS may indicate on the calendar, time tracker report, and/or timesheet the inactive time period.

In some embodiments, the user can view one or more time trackers associated with the user or the project. In some embodiments, the user can view one or more time trackers associated with programs that are currently running on the computing device. In some embodiments, the user can filter or search for timers. For example, the user can view all time trackers that have been used in the last day, week, month, year or any other time period. In another example, the user can view all time trackers associated with a certain task or client.

In some embodiments, the time tracker can be paused or resumed by the user. In other embodiments, the TTS can automatically pause or resume tracking time based on the user's interaction with the program associated with the time tracker. For example, the time tracker may resume tracking time when the program with which it is associated is the active window on a computing device. Further to this example, the TTS may automatically pause the time tracker when the window associated with the time tracker is minimized or closed.

In some embodiments, the TTS may use rules to start/stop or pause/resume tracking time based one or more user interactions. For example, the TTS may pause a timer if the user has not interacted with a program for a certain amount of time. For example, if the user has not interacted with a program for over five minutes, the TTS may pause the timer, even though the program is the active window. In some embodiments, the TTS may prompt or notify the user as to whether the timer should be paused. For example, if the user has not interacted with the program for five minutes, the timer may prompt the user as to whether the timer should be paused, and, upon receiving no response, automatically pause the timer.

In some embodiments, The TTS can include an interface that allows the entity operating the TTS or a user to enter one or more time tracker rules based on one or more user interactions. For example, others rules the time tracker can use to track time may be based on, e.g., how often the user saves a file, when the user saved the file, how the file changed, how the user interacted with the file, how the user interacted with the application, etc. For example, if the user simply launched a program, loaded a document, printed the document, and then terminated the program, the time tracker may not track any time or update the timer. In another example, the timer may not track any time if the document was launched and closed without any change, e.g., the user did not edit the contents of document.

In some embodiments, the user can adjust any time data associated with a timer via the user interface. In some embodiments, the user can select the timer and alter the time and/or project ID. In some embodiments, the user may add time to the timer or deduct time from the timer.

In some embodiments, the time tracker may include a countdown timer. For example, the user may enter a time via the user interface of the time tracker. The countdown timer may represent the amount of time the user wants to spend on a task, the amount of time allotted for the task, the amount of time budgeted for the task, the amount of time the user wants to spend working on a given day or at a given time, etc. In some embodiments, the countdown timer may represent a category of time. For example, the user may enter the amount of time the user wants to work in a given week, regardless of client, task, project, etc. For example, the user may be required to work forty hours in a given week. The user may then enter forty hours into the countdown timer. The countdown timer may start counting down whenever the user is performing a task that is associated with a certain category. The user or the entity that operates the TTS may set one or more categories, including, e.g., billable time, non-billable time, administrative tasks, overhead charges, professional development, business development, training, etc. Categories may be further associated with specific software applications, including, e.g., a word processor, a presentation program, a spread sheet programs, an Internet browser, graphic editing program, etc.

In some embodiments, the time tracker may provide alarms and/or reminders. The alarm functionality may facilitate performing a task within a certain budget or within a certain amount of time. For example, the user, TTS, project manager, or any other entity may set an alarm for a time tracker associated with a project ID. The alarm may notify the user after a certain amount of time has been spent performing a task. For example, a graphic editing task may have a fixed budget that results in the graphic editor being able to spend five hours on the task. The time tracker may be configured to automatically signal an alarm or otherwise notify the user at various time intervals, such as hourly or at certain percentage intervals, e.g., 50%, 75%, 90%, etc. In another example, the user may set an alarm that notifies the user after a certain amount of time so the user can perform a different task for the same or different project. For example, the user may set a four-hour alarm for a specific task. After performing the task for four hours, the alarm can notify the user in a plurality of ways, including, e.g., audio, visual, pop-up prompt, email, or text message. In some embodiments, the TTS may automatically terminate the associated program or otherwise direct the program to perform a certain function. For example, after four hours, the TTS may automatically save the associated document and terminate the software application, thus forcing the user to transition to another task.

The TTS 120 can comprise a data capturer 225 designed and constructed to capture data associated with time being tracked. The data capturer may comprise an application, program, library, script, service, process, task or any type and form of executable instructions executing on a device, such as a client or a server. The data capturer can be configured to interface with any other module or engine, including, e.g., an interface, policy engine, activity identifier, time tracker, timesheet module, project manager, database, and billing agent to perform a plurality functions.

In some embodiments, the data capturer can capture a plurality of information associated with an open file in order to report time. The data capturer can capture at least two types of data: time capture data and snapshot data. Time capture data can include, e.g., file saves, mouse/action, on focus vs. not on focus, changes in window attribute data, file edits, printing, and any other user interaction with the program or program function. Snapshot data can include, e.g., preview snapshots of an open file. For example, a preview snapshot may be a snapshot of the open document in a word processing program, an image in a graphic editing program, or an entire snapshot of the entire screen or application window. In some embodiments, snapshot data can include real-time creation of ‘title cards’. Title cards may be a visual representation of a non-visual file, e.g., a title card for a software program that is being developed by a software engineer could include the name of the file, timestamp of activity, changes in the file (such as the definitions of functions, methods or other components of the software), etc. The data capturer can take file snapshots at predetermined intervals or on command.

In some embodiments, the TTS can push files to a storage repository or database (e.g., stored on a server via a network) and provide visual cues that may allow a user to ascertain that the source file exists for the particular saved ‘moment in time’. The user may be able to retrieve the pushed file via the TTS.

In some embodiments, the data capturer can associate the capture data with an identifier determined by the activity identifier, such as a project ID or task ID. The data capturer may further associate the captured data with a user, time, date, geographic location, or any other information that can facilitate the accurate and efficient reporting of time as well as facilitate searching time history. The data capturer can store the captured data (e.g., time capture data and preview snapshot data) in the database 240.

The TTS 120 can comprise a timesheet module 230 designed and constructed to populate a timesheet and perform other functions related to the timesheet. The timesheet module may comprise an application, program, library, script, service, process, task or any type and form of executable instructions executing on a device, such as a client or a server. The timesheet module can be configured to interface with any other module or engine, including, e.g., an interface, policy engine, activity identifier, time tracker data capturer, project manager, database, and billing agent to perform a plurality of functions.

The timesheet module 230 can populate a timesheet in real-time, on regular intervals, on set days, or upon user direction. In some embodiments, the timesheet module may populate a timesheet at the end of the day, week, month, or any other predetermined interval. For example, the time tracker may track time throughout a given work day. At the end of the work day, the timesheet module may receive the tracked time data and populate a timesheet with time data, activity identifier data, user information, task information, and any other data associated with the tracked time. In some embodiments, the timesheet module may automatically populate a timesheet when the user terminates a program that is being tracked. In some embodiments, the timesheet module may prompt the user for user input prior to populating the timesheet. For example, upon detecting that the user terminated a program that was being tracked, the timesheet module may prompt the user for input regarding whether or not to populate the timesheet.

The timesheet module 230 may allow the user to view, modify, or analyze tracked time via a user interface. In some embodiments, the timesheet module may populate the timesheet with time tracked by the time tracker and then prompt the user to verify that the entered time is accurate. The timesheet module may further allow the user to modify one or more time entries or data associated with the time entry, including, e.g., a project ID, a description, user ID, or any other data associated with the time entry.

In some embodiments, the timesheet module may receive timesheet verification from an entity that is not the user. For example, upon receiving timesheet data from the user, the timesheet module may prompt a project manager, finance manager, or accountant to review the timesheet and verify that the entered information is correct. For example, the user may have entered the wrong client number or the client ID or the task ID may have changed after the time was tracked and the timesheet was populated. In some embodiments, the TTS can automatically analyze the time data and determine whether one or more data is improper, e.g., an incorrect Project ID, conflicting times, spelling errors, etc. For example, the time data may be improper if the user is not associated with project team. The TTS may then prompt the user to correct the data.

The TTS may provide a plurality of interfaces or viewing, analyzing, and modifying the timesheet. In some embodiments, the user interface may be optimized for a touch screen enabled computing device. For example, the TTS may recognize one or more touch gestures that correspond to one or more functions, including, e.g., viewing detailed information about a time entry, expanding or shrinking the length of time of a task, moving a task from one time or day to another time or day, etc.

In some embodiments, the timesheet module may provide visual automated timesheet fill in where the timesheet module automatically visually fills in time data based on automated tracking. The timesheet module may present the user with a thumbnail for each time entry that includes additional information about the time entry, including, e.g., a preview snapshot, time, date, duration, filename, user ID, project ID, or any other time information.

In some embodiments, a user can search time history via the timesheet module. The timesheet module can provide for various search interfaces, including, e.g., flip through thumbnails/preview snapshots, keyword search, natural language search, index search, category search, timeline search, etc. Example illustrations of TTS user interfaces are depicted in FIGS. 4A-E.

The TTS 120 can comprise a project manager 235 designed and constructed to facilitate managing a project and one or more functions related with the project. The project manager may comprise an application, program, library, script, service, process, task or any type and form of executable instructions executing on a device, such as a client or a server. The project manager can be configured to interface with any other module or engine, including, e.g., an interface, policy engine, activity identifier, time tracker, data capturer, timesheet module, database, and billing agent to perform a plurality functions.

In some embodiments, the project manager manages a workflow manager. The project manager may be configured to notify employees to submit their time data at the end of the day, week, or some other time interval. The project may be configured to monitor the status of a project and the amount of time spent on the project. For example, the project manager may include an interface where a user can view all time spent on a project, data about each time entry, including captured time data, preview snapshots, user information, or any other tracked data associated with the time entry.

In some embodiments, the project manager may provide various alerts and notifications based on the status of the project. For example, if the project is allotted 200 hours and there are five users working on the project, the project manager may send a group alert to the five users when they have each spent twenty hours on the project (i.e., 50%) or when the group, as a whole, has spent 100 hours on the project (i.e., 50%). The project manager may be further configured to alert or notify users that are behind in their time submissions. For example, the program manager may alert the user if the user has only entered ten hours of time by the end of the week.

In some embodiments, the program manager may provide real-time time tracking. For example, the program manager may receive, in real-time, tracked data that has not been formally submitted to a timesheet. In some embodiments, a user can enable or disable real-time tracking, or be prompted before the program manager can display real-time tracking.

In some embodiments, the project manager may analyze the time data to improve scheduling and/or resource planning. For example, the project manager may analyze the amount of time spent on certain tasks to predict how long those tasks may take in the future. For example, there are three task types: A, B, and C. The project manager may analyze historical timesheet data to determine that task type A takes an average of 10 hours, task type B takes an average of 5 hours, and task type C takes an average 20 hours. Furthermore, the project manager may determine that different users take different amounts of time to perform different tasks. For example, user1 may take an average of 10 hours to perform task type A, but take an average of 15 hours to perform task type B, whereas user2 takes an average of 20 hours to perform task type A and average of 3 hours to perform task type B. Accordingly, the project manager may automatically determine that user2 should be given more tasks under task type task B and user1 should be given more tasks under task type A. Or, on the other hand, an employer may use this information to better train user2 on how to perform task type A. In some embodiments, the project manager may analyze historical timesheet data to predict when a project or task will be complete.

The TTS 120 can comprise a game module 250 designed and constructed to gamify time tracking. The game module may comprise an application, program, library, script, service, process, task or any type and form of executable instructions executing on a device, such as a client or a server. The game module can be configured to interface with any other module or engine, including, e.g., an interface, policy engine, activity identifier, data capturer, timesheet module, project manager, database, and billing agent to perform a plurality functions.

The TTS may encourage users to enter time on a regular basis by making time entering more gamelike. For example, the game module may maintain a leaderboard that consists of users who enter time on a daily basis. In some embodiments, the game module may encourage accurate time entry. For example, users who enter time daily and do not need to modify time data at the end of the week may be recognized in one or more ways, including, e.g., by displaying a username on a leaderboard. In some embodiments, the game module may provide the user with a reward. Rewards may be monetary or other types of rewards. For example, if a user accurately and timely submits their timesheet, the game module may provide the user with additional vacation time, or reduce the number of billable hours required for the week, or provide any other time of reward.

In some embodiments, the game module may enter a user into a random drawing for something of value, such as a prize. In some embodiments, the reward may be to showcase a work product to a certain group of users, e.g., other users associated with a certain project, company, client, or industry team. In some embodiments, users may vote on the displayed work product, provide comments or feedback on the work product, or otherwise interact with the user that generated the work product.

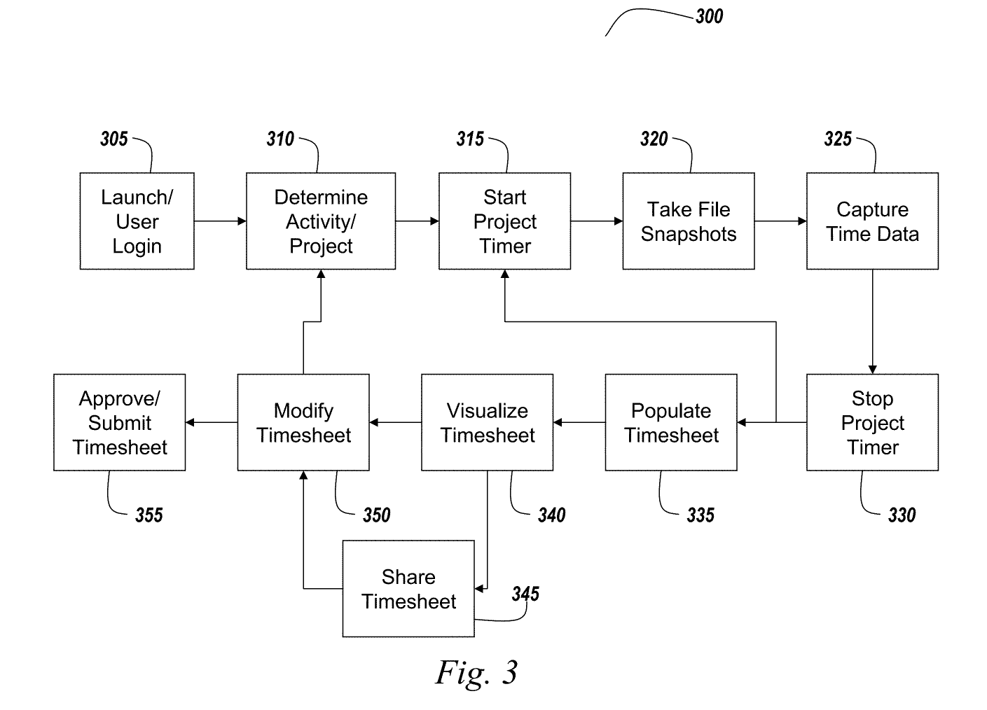

Referring now to FIG. 3, embodiments of a method for tracking time is depicted. In brief overview, the method may include the steps of data collection (automated or manual), data clean-up, data visualization, and/or data submission. At step 305, the TTS application is launched and the TTS system is logged into. Users, project managers, timesheet reviewers, or any other entity associated with the project and tracking time may perform step 305. At step 310, the TTS may determine an activity or project ID associated with the task the user is performing. At step 315, the TTS may start a timer. At step 320, the TTS may take file snapshots. At step 325, the TTS may capture time data, including, e.g., the time and/or number of saves, mouse clicks, etc. At step 330, the TTS may stop a project timer in response to an event. At step 335, the TTS may populate a timesheet associated with a user and/or project. At step 350, the TTS may modify a timesheet or allow a user of the TTS to modify a timesheet. At step 345, the TTS may share the timesheet with another user or entity. At step 350, the TTS may perform automatic analyses of the timesheet and prepare one or more timesheet reports. At step 355, a user of the TTS may approve the timesheet and the TTS may formally submit the timesheet. In some embodiments, the TTS may further generate an invoice based on the timesheet and submit the invoice to an entity for payment. These steps may be performed by one or more clients, servers, engines, and/or modules described above.

In further detail, at step 305, components of the TTS application are launched. In some embodiments, users may log in to the TTS application via various authentication techniques. The user may launch the TTS application from a user client. In one embodiment, the TTS application may be launched from within the program being used to perform a task, such as a graphic design program, word processing program, spreadsheet program, presentation program, video editing program, or any other program. In some embodiments, the TTS application may launch concurrently with a program, or it may be launched by making a selection within the program. In another embodiment, the TTS application may be automatically launched when a user client receives a notification from the TTS. In yet another embodiment, the TTS application may be a stand alone application running on a user client.

At step 310, the TTS may determine an activity ID or project ID. In some embodiments, the TTS may receive the ID from a user or client device. In some embodiments, the TTS may receive an ID in response to prompting the user for an ID. The prompt may include a lookup table that includes one or more available IDs, client names, task names, or any other information that is associated with a project or job ID. In some embodiments, the TTS may automatically determine an ID based on a plurality of factors. For example, the TTS may determine an ID based on one or more of the user, time of day, duration of task, type of application used to perform the task, content of a file, and metadata associated with a file.

At step 315, the TTS can start a project timer. In some embodiments, the user can manually start the project timer. In some embodiments, the TTS can automatically start a project timer in response to a user's interaction with the computing device. For example, the TTS may automatically start the timer in response to the user launching a program and performing a function related to the program, such as typing in a word processing document. In another example, the TTS may automatically start a timer when the user brings a program window to the foreground, i.e., makes it the active window on a computing device.

In some embodiments, the TTS may start the project timer from zero and count up. In some embodiments, the project timer may start at another number. For example, the project timer may include all time spent on a given task that has not yet been submitted to a timesheet. For example, the user may have spent five hours on a task on Monday and terminated the program without submitting or cleaning up the time. On Tuesday, the user may launch the TTS and associated program and start working on the same task. Instead of starting the project timer at zero, the TTS may start the project timer at five hours to include the time spent on the project on Monday. The timer may include a visual representation of the data, such as a visually segmented horizontal bar chart, that includes: “Submitted time”, “Unsubmitted time” and “Remaining time budget”. In the case where a project runs over budget, there may be a fourth category “overbudget time”. A plurality of other categories may exist in various embodiments.

In some embodiments, the project timer may be a countdown timer. In these embodiments, the TTS may prompt the user to enter a timer from which to countdown. In some embodiments, the TTS may automatically retrieve a countdown time based on a plurality of factors. For example, the TTS may retrieve a countdown time associated with the project or type of task from a database. For example, a certain type of task may be allotted a certain amount of time. In other embodiments, the TTS may determine the amount of time for a task based on an historical analysis of data stored in the database. For example, the user may have performed this task ten times in the last month and each time took five hours. Thus, the TTS may predict that the user should take five hours to complete task and set the countdown timer accordingly.

At step 320, the TTS can take file snapshots. A file snapshot may be a preview of the file that is being tracked. In some embodiments, the TTS takes file snapshots for a plurality of open programs that are being tracked. The TTS may take file snapshots at regular intervals, based on user interactions, or when manually directed by the user. For example, the TTS may take a preview snapshot of a word processing document every time the user saves the word document. In other examples, the TTS may take a preview snapshot of an email program or Internet browser every time the user opens a new email or web page. The TTS may associate file snapshots with a project ID, user, time, day, status, or any other criteria that may facilitate reporting and time entry.

In some embodiments, the TTS may upload the file snapshots to a central server in real-time. In other embodiments, the TTS may upload the file snapshots in a batch upload at a predetermined time. In some embodiments, the TTS may store the file snapshots on the client device. In some embodiments, the TTS may encrypt the file snapshots to prevent unauthorized access.

At step 325, the TTS captures time data. Time data may include any information about the program that is being tracked, including, e.g., user interactions, file saves, print, change in window attribute data, mouse actions, keyboard input, focus vs. not on focus, etc. In some embodiments, the TTS captures time data simultaneously for a plurality of programs being tracked.

At step 330, the TTS stops or pauses the project timer. The TTS may automatically stop or pause the timer based on a user interaction or lack of user interaction. For example, the TTS may apply one or more time tracker rules to determine when to stop or pause the timer. Time tracking rules may based on program idle time, program functions, user interaction with the program, etc. For example, the TTS may automatically stop or pause a timer if the program has been idle for more than five minutes. In another example, the TTS may automatically stop or pause a timer if a program window has been minimized. In another example, the TTS may automatically stop or pause a program if the user launches another program. In some embodiments, the TTS may receive an indication to stop or pause a timer from a user via a user interface.

In some embodiments, the TTS may resume the timer at step 315. For example, the user may resume performing a task after taking a break, at which point the TTS may automatically resume the project timer associated with this task at step 315.

At step 335, the TTS can automatically or manually populate a timesheet. In some embodiments, the TTS may prompt the user to submit time data to a timesheet. The timesheet may be for a day, week, month, project duration, or any other time period. In some embodiments, the user may select one or more time entries or projects to be submitted to the timesheet.

At step 340, the TTS may provide one or more visualizations of the timesheet. Visualizations may be any type of visualization that can be conveyed via the graphical user interface. In some embodiments, the visualizations may be optimized based on the computing device. For example, the visualization may be optimized for a smart phone or a tablet computer with a touch screen.

In some embodiments, the visualization may resemble a calendar view. The calendar view may include the five weekdays that constitute the work week. The calendar view may further include time slots for each working hour during the weekday. The calendar may populate each time slot with a tracked time entry. Each time entry may include additional time data for each time entry. The time data may include any time data that was tracked by the TTS, including, e.g., time capture data, preview snapshot data, file data, user information, project information, etc. In some embodiments, the visualization may include one or more thumbnails that, when selected, present the additional information associated with the time entry.

At step 345, the TTS can share a timesheet with other users or entities. The TTS may share the timesheet with authorized entities, such as other users associated with the same employer, project, client, or otherwise permitted to access the timesheet. In some embodiments, users viewing the shared timesheet may make comments regarding the timesheet, modify the timesheet, alter data in the timesheet, search the timesheet and associated file snapshots, or perform any other function associated with the timesheet. In some embodiments, users viewing the shared timesheet may only be permitted to perform a subset of functions associated with the timesheet, e.g., they may not be able to deduct the amount of time on the timesheet, add time to the timesheet, or change a user ID.

At step 350, the TTS may modify the timesheet. In some embodiments, the TTS may automatically modify the timesheet based on one or more rules. For example, the user may be required to enter a forty hours of time in a given week. If the user only submitted thirty hours of time to the timesheet, then the TTS may automatically enter ten hours of time under a time ID such as vacation time, sick leave, administrative time, and/or some other time ID. In some embodiments, if the user entered fifty hours of time in a given week, the TTS may automatically change the ID for time over forty hours to an overtime ID. For example, the TTS may include a “Smart Complete” functionality that can allocate time from these additional time IDs to several ‘remnant’ or ‘orphaned’ timeslots.

In some embodiments, the TTS may prompt a user to modify the timesheet. The TTS may provide the user with a visual representation of the timesheet for the user to modify. For example, the user may have performed one or more tasks that were not tracked by the TTS. Accordingly, the user may notice that no time (or the wrong task) was tracked between 11 AM-12 PM because the user was performing a task not on the computing device, e.g., analyzing a printed document. Thus, at step 350, the TTS may receive a modification to the timesheet that corrects or improves the accuracy of a time entry or information about a time entry. In some embodiments, the TTS may automatically modify the timesheets based on the feedback provided by users with whom the timesheet was shared.

At step 355, the TTS may receive an approval for the timesheet. In some embodiments, a user may approve the timesheet or the TTS may automatically approve the timesheet if the timesheet satisfies certain criteria. For example, a rule may be: if 40 hours, timesheet approved. Another rule may be based on feedback, e.g.: if no negative feedback of sharing timesheet, then approve timesheet. Another rule may be based on a duration, e.g.: if timesheet shared with manager for 48 hours without the timesheet being denied, then timesheet approved.

In some embodiments, the TTS may additionally generate an invoice based on the timesheet and submit the invoice for payment. In some embodiments, the TTS may electronically transmit the invoice via a network. In other embodiments, the TTS may submit the invoice to an accounting that may then submit the invoice for payment.

Referring to FIG. 4A, an illustration of a graphical user interface for visualizing a one week timesheet is shown. The visualization can include a variety of views, including, e.g., a detailed view, simple vie, visual history, day view, week view, and month view. The time slots may be set to 15 minute intervals. The GUI can include additional information, such as a tally of the total number of hours billed during the week and the number of missing hours (e.g., the number of hours to need to reach 40 hours in a week). The visualization may include a summary of time spent (absolute or percentage of overall time or percentage complete for each project) on each project during the week or over a certain duration of time. The visualized timesheet may be interactive. For example, the user may start, stop, or break the timer by selecting the corresponding button. The GUI may allow the user to submit the timesheet, add additional projects, or may provide for smart complete, which automatically bills all remaining time up to 40 hours to an admin/non-billable charge number (e.g., vacation time or could segment and allocate several blocks of time towards several project IDs.). The project boxes on the visual timesheet may also be interactive, e.g., selecting a project box may expand to reveal additional project information, job IDs, project comments, etc.

The visualization includes time information about each project worked on by the user. In this example, the user is associated with seven projects, six of which were working on during the week. Each project may be represented by a different color on the calendar. On Monday, the user worked on projects 2 and 5. The user worked on project 2 from 9 AM to 12 PM, and then worked on project 5 from 1 PM to 6 PM. The visualization shows that on Monday the user did not work on any task between 12 PM and 1 PM. In this example, the user may have taken a lunch break between 12 PM and 1 PM. In another example, the user may have been at a lunch meeting that was not tracked by the time tracker. Upon viewing this visualized timesheet, the user may determine that project 2 should extend to 1 PM. In some embodiments, the user may use one or more finger gestures to extend the stop time of project 2 from 12 PM to 1 PM. For example, the user may use two fingers to stretch the project 2 time entry. In another embodiment, the user may select the time entry and modify the stop time.

The visualized timesheet for Tuesday shows that the user worked on project 2 from 9 AM to 10 AM and project 1 from 10 AM to 6 PM. The visualized timesheet further shows the amount of time billed for each day, e.g., the user billed 8 hours on Monday, 9 hours on Tuesday, 8 hours on Wednesday, 5 hours on Thursday, and 4 hours on Friday. In some embodiments, the user can view additional information about a time entry by dragging a mouse over the time entry or otherwise selecting a time entry with a finger gesture. For example, the mouse is shown to hover the project 1 time entry on Friday, which results in a “+” appearing on the bottom right corner of the time entry. The detailed information is shown in FIG. 4E.

In some embodiments, the visual timesheet may facilitate resolving conflicting time entries. For example, a user may have entered multiple project IDs for a given time period, i.e., the user may have indicated that they worked on multiple project at the same time. In some examples, this may be accurate if the user is efficiently multitasking. In other scenarios, this may be an error on the part of the user that must be resolved. In some embodiments, the TTS may automatically resolve the error based on captured time data and/or snapshot data. In other embodiments, the user may analyze the snapshot data to manually correct the error.

Referring to FIG. 4B, an illustration of a graphical user interface for visualizing a one week timesheet is shown. In some embodiments, the visualized timesheet may automatically hide non-billable time. For example, the timesheet may hide time entries associated with administrative tasks, professional development, training, vacation time, etc. This timesheet user interface includes a smart complete function that allows the user to indicate an ID to which all remaining time should be entered. The GUI may include a drop down menu with the available time entry IDs. The GUI may allow the user to enter the number of hours. In this example, the user may enter Admin (#1001) and 2 hours.

The timesheet GUI includes a plurality of data about the projects associated with the user, including the client name, project name, project ID and a color code. The projects may be categorized by client. For example, the client Kimberly Clark includes projects Cottonelle, Huggies, and Kleenex. The client coca-cola includes projects CC March Ad. The non-billable category includes time entries Admin and NB/Misc.

Referring to FIG. 4C, an illustration of a graphical user interface for the Time Tracker Day View is shown. This view shows all the activities performed for each project on Friday, April 13th. For example, from 9-LOAM, the TTS includes a plurality of activity details. Activity details may correspond to captured data, preview snapshots, user-entered descriptions, or any other information associated with the tracked time. For example, from 9-10 AM, the TTS includes details for four activities. The user may select each activity to get additional information about the activity, such as a snapshot or details. From 10 AM-1 PM, the TTS includes details for five activities. The length of the activity corresponds to the amount of time spent on the activity, where each increment is 15 minutes. During this time, the user concurrently performed three activities. For example, the three activities may correspond to interacting with three documents, e.g., a word processing program, Internet browser, and presentation program. Selecting the activity may provide a snapshot for each activity or additional details about the activity. The user may further modify the duration of activities or other information associated with the activity.

Between 1 PM-2 PM, the GUI shows that the user did not perform a billable task. For example, the user may have been traveling from one work site to another work site. As shown in the GUI, the TTS may receive GPS information associate with the users travel. The user may enable or disable GPS tracking. In some embodiments, the TTS may prompt the user to enable GPS tracker prior to the TTS tracking GPS data. In this example, the user enable GPS tracking, and the TTS has includes the GPS data in the visual timesheet.

Referring to FIG. 4D, an illustration of a graphical user interface for a visual timesheet thumbnail is shown. A user may view a thumbnail by selecting an activity via a user interface. The thumbnail may display a preview snapshot of the activity, file name, when the file was opened, how many times the file was saved, when the file was last saved, when the file was closed, and the project the file or activity is associated with. In some embodiments, the TTS can export this data to a data file or other appropriate formats for reviewing or modifying the data. In some implementations, the TTS can directly or indirectly integrate with a third-party's back-end system. For example, the TTS can directly integrate with a third-party billing agent that is responsible for sending out a billing invoice, performing an audit, and/or paying the bills.

Referring to FIG. 4E, an illustration of a graphical user interface for a visual timeline is shown. The visual timeline may be a three dimensional data visualization. In the middle, a visual asset thumbnail that is in focus for the particular moment in time is shown (405). The time may be determined by the interactive scrub bar 402 on the bottom of the GUI. The smaller items (e.g., 410 and 415) on each side of the in focus item 405 represent the items that were previously in focus (410) and are next in focus (415), e.g., activities that precede and follow the in focus item. The other boxes show thumbnails of other files that were opened at that same time. The size of each box (e.g., 410 and 415) represent how long the file was open (or some other indication of usage, which may be configurable by the user). The items may be painted in various colors that may represent a project ID or provide some other indication.

The visual timeline includes an interactive scrub bar 402. The scrub bar may include a beginning time 420 and an end time 440. In some embodiments, the beginning and end times (420 and 440) may include dates, bookmarks, event names, or any other temporal indication. The scrub bar includes a knob, scroll bar, button, or other user interface element (425) that provides for changing a time in the visual timeline. In some embodiments, the knob 425 can be modified, changed, or moved via a mouse click, touch gesture, shake, accelerometer or gyroscope input, etc. The interactive scroll bar may include markers 430. The markers may represent bookmarks set by the user or automatically set by the TTS based on one or more factors. For example, the marker may represent the status of a file, a project milestone or other event related to the project. In another example, the marker 430 may represent a type of file or project ID. The visual timeline may include a toolbar for changing the size of the thumbnails 434.

The TTS may provide a plurality of functionality via the visual timeline user interface. In some embodiments, the visual timeline can provide search, analyses, filtering, reporting estimating, budgeting and other functionality. For example, the user may want to view, via the visual timeline, only files that are associated with a certain ID, e.g., for a specific client or project. The user may enter one or more filtering criteria via the user interface (e.g., input text box, drop down menu, lookup table, etc.). The TTS may then display, via the visual timeline, only those files that satisfy the filtering criteria.

FIG. 4F depicts an example embodiment of a graphical user interface for the systems and methods described herein.

While the invention has been particularly shown and described with reference to specific embodiments, it should be understood by those skilled in the art that various changes in form and detail may be made therein without departing from the spirit and scope of the invention described in this disclosure.

What is claimed is:

1. A method for tracking time comprising:
obtaining, via a timer embedded in an application executing on a first device, a first time information;
associating the first time information with a first task identifier;
generating a timesheet based on the associated first time information, the timesheet comprising a unique indication of the first task identifier;
displaying the generated timesheet on a display of a mobile device;
modifying, via a touch interface of the mobile device, the generated timesheet to include a second time information, the second time information corresponding to a second task identifier;
displaying, via the display, the modified timesheet with a unique indication of the second task identifier; and
submitting, via the mobile device, the timesheet to a time tracker server.
